(19) United States
(12) Patent Application Publication
(10) Pub. No.: US 2012/0205997 A1
(43) Pub. Date: Aug. 16, 2012

(54) Self-contained & propelled magnetic alternator & wheel DirectDrive vertical units. aka:MAW-DirectDrives vertical model

(75) Inventor: Dana Allen Hansen, Torrance, CA (US)

(73) Assignee: Mr. Dana Allen Hansen, Torrance, CA (US)

(21) Appl. No.: 12/931,777

(22) Filed: Feb. 10, 2011

(51) Int. Cl. H02K 5/18

(52) U.S. Cl. 310/64

(57) ABSTRACT

MAW-DirectDrives Vertical Models are direct drive propulsion and electrical generating units for transportation vehicles utilizing wheels for motion, which connect onto the inside of wheels actuating rotation and braking electromagnetically while simultaneously utilizing the rotation to generate electricity to feed back into the supply for reducing the vehicle's requirement for operation. Two pancake style direct drive permanent magnets stators are mounted on sturdy metal mounting backs functioning as the unit's stationary outside faces and outer portion of the unit's wheel hub. The vehicle is supported from their rear face. The stators face one another with a two-sided permanent magnets drive-rotor disc between them accomplishing two functions simultaneously. The drive-rotor is connected to the Integrated Drive-plate Assembly's spindle perpendicular. The spindle with its threaded end traverses through each wheel hubs' bearings and unites the unit together with a lock nut. An attached exterior cylindrical housing keeps the unit rigid and parallel.

### CROSS-REFERENCE TO RELATED APPLICATIONS

This non-provisional utility patent application references all specifications and standards set forth within my provisional patent applications and non-provisional Utility patent application filed under my customer number: 000079682. Said applications being referenced are: Provisional patent application No. 61/336,824 filed on Jan. 27, 2010 plus Provisional patent application No. 61/124,179 filed on Apr. 15, 2008 with corresponding Non-provisional Utility patent application Ser. No. 12/386,047 filed on Apr. 13, 2009 under Class/Subclass: 180/065.510 having a Publication No. US 2009-0255742 A1.

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1. Field of the Invention

MAW-DirectDrives and newly created MAW-DirectDrives Vertical Models henceforth referenced as “Vertical Models” where design differences are indicated are designed and created to reduce the on-board storage or production requirement of electrical power for electric vehicles that utilize the wheel format for their travel.

They are designed to increase the vehicle's efficiency by harnessing the kinetic energy within the vehicle during motion by utilizing the rotation of every wheel to generate electricity and assist with its own production of electrical power, while simultaneously directly accelerating and braking each wheel independently with sufficient power/torque to move the load without the need of gearing or the transmission of power from a central location.

They are designed to incorporate this ability economically into every format of land transport (road and rail) to pave the way for a future standard all electric form of propulsion for land transportation and end an era of reliance on non-efficient mechanical production of power and its transmission.

MAW-DirectDrives additionally are designed to incorporate today's most efficient and powerful electromagnetic propulsion, brake and electrical generating technologies to produce and create the power necessary for its application to encompass all formats of land transportation and enable a standard to be created for the propulsion of land transportation and for society to benefit/gain from that standardization.

MAW-DirectDrives with the incorporation of state of the art technologies in this manner will produce more torque and induce rotation with more power and efficiency than today's single stator formats which can be utilized wherever rotation is needed.

MAW-DirectDrives also reduce efficiency loss associated with electromagnetic power production and generation due to the effects of magnetic drag or the principles pertaining to magnetic attraction, to increase performance and efficiency.

MAW-DirectDrives design/form is uncomplicated to simplify the manufacturing and assembly process plus facilitate their smooth implementation into transportation vehicles; in addition it will enable the straightforward integration of future technology like radar and GPS communication and guidance via the computer's control without the need for alteration or modification for its accommodation.

2. Description of Related Art

Present transportation technology since its inception has used power-plants that utilize numerous mechanical parts to produce torque to rotate a shaft coupled to assemblies or additional mechanical devices which add more mechanical parts to the total, all to process and make that torque usable and ready for transmission to the wheel(s) via even more assemblies and mechanical devices, to propel a vehicle.

With these systems the efficiency is degraded every time the power/torque encounters friction, alteration, a change in direction or delay and when compounded with the torque originating from a rapid small diameter, possessing characteristics that require extensive processing and the use of these assemblies and mechanical devices, the torque produced by these power-plants in the end has degraded significantly and made the vehicle inefficient.

Present Hybrid technology is attempting to reduce the number of parts associated with the drive-train and eliminate the losses associated with those parts, but the torque being produced is still originating from a rapid small diameter and requires that processing and transmission, ultimately making the vehicle inefficient.

There are a few companies like e-traction in the Netherlands producing vehicles (buses and delivery trucks) that utilize a direct drive format where the electrical motor connects directly to the wheel eliminating the losses associated with a centralized power production format but they have limited their torque production ability and efficiency with their designs inability to grow in diameter.

All Electric, Hybrid and Direct Drive technologies today understand regenerative braking and its value in stopping a vehicle while at the same time utilize the energy produced during the braking process to assist in decreasing the on-board demand for electrical storage or production, but they do not take advantage of the kinetic energy that a vehicle possesses during travel as they do in braking.

All Electric, Hybrid and Direct Drive technologies also refrain from relying on Electronic braking to stop and hold a vehicle due to heat build-up and losses associated with that process produced by high amperage(s) applied to small surface areas.

With today's rail transportation format being the architect of Hybrid technology, both rail and commercial trucking still resort to a central/core power-plant causing to rotate a limited number of wheels to pull a heavy load that on the most part is supported on numerous wheels just bearing the load for conveyance and offering no assistance/help.

Using the laws of motion the energy potential for any vehicle is proportional to their mass and velocity/momentum (linear momentum) and available to harness during the entire time of travel and one way to capture and harness that energy (kinetic) is to utilize the rotation of the wheels to essentially operate connected wind generators.

Thru the incorporation of state of the art wind generation technology and modern direct-drive BLDC motors designed for machinery and the transportation industry, these two technologies united together as a unit to connect to each wheel on transportation will efficiently and smoothly propel and stop any size vehicle and continually generate electricity during motion in proportion to their linear momentum to pave the way to an all-electric standard format of propulsion for land transportation.

By uniting the two technologies together in the design's configured state they become complementary and work together to reduce the end result associated with magnetic drag (not individually but as a unit) to increase the performance and further reduce the electrical demand.

### BRIEF SUMMARY OF THE INVENTION

MAW-DirectDrives and Vertical Models are creative new propulsion units for transportation vehicles utilizing wheels for motion.

They're self-propelled independent direct drive units that connect to the inside of wheels.

Vertical Models rotate and stop electromagnetically and use the rotation of the wheel to generate electricity thru the incorporation of two pancake style direct drive brushless permanent magnets BLDC motors.

They make possible an ability to capture and utilize the kinetic energy within the moving vehicle proportional to their linear momentum by the incorporation of the second motor/alternator.

They have one moving part and their natural high power/torque produced throughout their entire operating range eliminate the need for efficiency reducing power conversion and transfer formats (i.e. gearing and differential).

Two separate pancake stators utilize their sturdy mounting backs which are externally ribbed for cooling as the flat circular surface forming the front and rear housing enclosures which have incorporated into the center a wheel hub housing counter bored from the face to accept sealed tapered roller bearings and the rear stator mounting back has two mounting bosses located adjacent the points of connection to the vehicle's suspension to facilitate the units connection to the vehicle in addition any modifications when needed to mount an optional air brake are designed in.

The flat inside face of the stators are finish ground to specifications then the mounting back's inside center is machined to proper depth one that enables the thickness of the cylindrical roller thrust bearing inserted between the stator and two-sided drive-rotor to also produce the specified clearance between them which also finishes the inner surface of the wheel hubs and produces a perfect flat surface for the final machining of the reverse side and counter boring the central wheel hubs at right angles for perfect concentricity, alignment and running true to the opposing stator.

The stators are separated and positioned face-to-face, to power and interact with a two-sided permanent magnets drive-rotor disc which is located between and connected to the drive-plate and spindle sub-assembly called the Integrated Drive-plate Assembly, the stator windings are matched to complement each other and their oriented to take advantage of magnetic principles to defeat drag and increase efficiency.

The drive-rotor has a wide boss on each side sized to hold a sealed cylindrical roller thrust bearing with a width equaling the opening between the mounting back with its stator and two-sided drive-rotor which includes the clearance between the stator and drive-rotor magnets plus the additional width of the bosses add stability and rigidity to the two-sided drive-rotor.

The spindle projecting inward/back from the drive-plate is keyed and machined for a press fit on the land between the two stators for the two-sided drive-rotor and connects the two stators with their mounting backs and the two-sided drive-rotor together via the sealed tapered roller bearings pressed into the wheel hub section of the stator mounting backs and to lock and secure both assemblies together with a zero tolerance a tightened custom spanner nut and external retaining ring is filled with a thick spacing washer plus the appropriate amount of shim washers.

The spindle's end on units employing the custom air brake is configured to accept the ride of the brake rotor using a ball spline format of travel to reduce friction plus increase efficiency and lifespan by milling longitudinal concave grooves from the spindle's end forward toward the retaining ring which correlate with the brake rotor's grooving and is kept disengaged by a strong die spring positioned outside the spindle around the brake rotor boss applying pressure against the brake rotor and spacing washer behind the locking spanner nut.

The brake housing incorporates a central air-cylinder with its internal piston and incorporated tapered roller thrust bearing riding in a hardened metal sleeve exerting pressure on the brake rotor and is positioned on location pins set into the rear stator's mounting back face plus secured by flat head machine screws; the spindle's end traverses through the inside diameter of the tapered roller thrust bearing within the piston and into a counterbore set further into the piston within the central air cylinder of the brake housing.

The rotating brake rotor is actuated/held in proportion to the input pressure and otherwise kept disengaged by the incorporated die spring and travels on tungsten carbide metal balls positioned in the grooves locking the parts together

The rotating brake-rotor via the piston within the housing's incorporated air-cylinder applies pressure inward on the stationary annular brake pad that is supported by its metal mounting back held in place on hardened location pins set into the rear stator's mounting back and possesses a carbon fiber reinforced ceramic braking surface to react to the carbon Kevlar brake surface on the brake rotor.

The unit's outer cylindrical housing is recessed in on both inside faces to properly locate the stators and is secured to the stators by flathead machine screws centered into the outer edge of the stator's mounting back and can be designed in an open framework style with inset filters for increased air flow, externally ribbed for cooling or externally ribbed incorporating an internal air manifold fed with compressed air via an input line, depending on the chosen configuration for the unit.

BY incorporating MAW-DirectDrives on every wheel each wheel is independently powered and generating back into the electrical supply during all motion and compounds that input during breaking operations utilizing regenerative braking principles. The overall input generated by motion and braking will benefit greatly the efficiency of all vehicles and reduce the vehicle's demand for onboard power production or storage.

### BRIEF DESCRIPTION OF THE SEVERAL VIEWS OF THE DRAWING

This patent application includes fourteen pages of drawings describing Vertical Models and the various components they are comprised of.

FIG. 1: is a scale drawing showing a side view cross-section of a basic convection cooled Vertical Model drawn to the patent application's reference outside diameter of nineteen inches for uniformity.

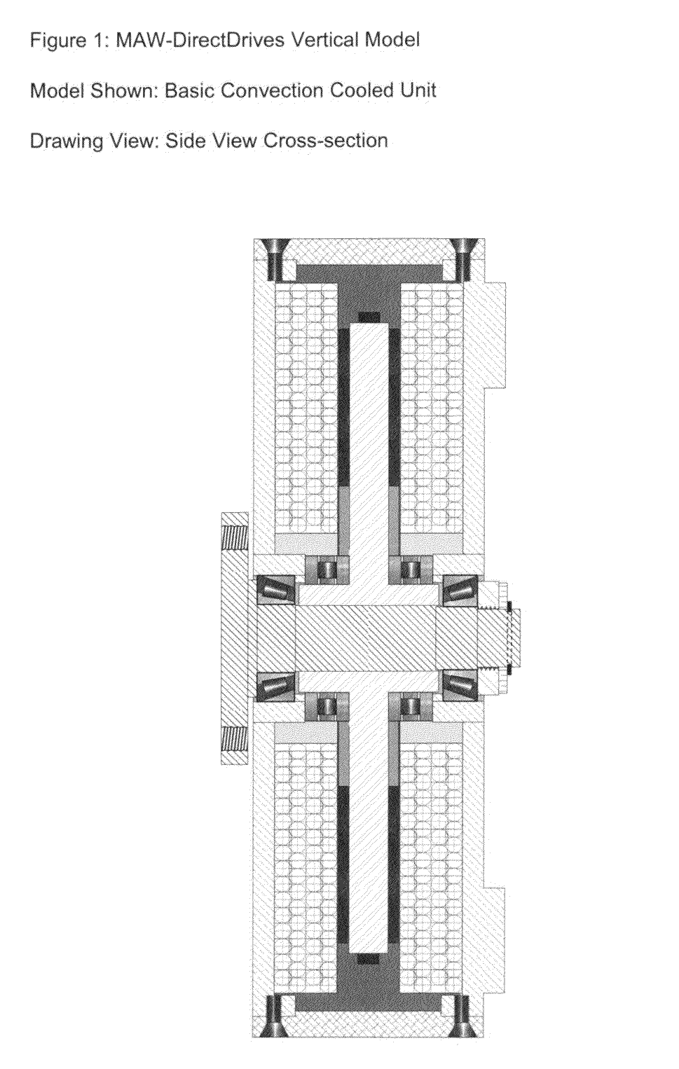

FIG. 2: is a scale drawing showing the exterior side view of a basic convection cooled Vertical Model incorporated with air filters.

FIG. 3: is a scale drawing showing the exterior front view without the Drive-plate of a basic convection cooled Vertical Model to show the ribbing configuration and inner cooling vents.

FIG. 4: is a scale drawing showing the front view of the 15″ OD Two-sided Drive-rotor used within the reference 19″ OD Vertical Model.

FIG. 5: is a scale drawing showing the side view cross-section of a compressed air cooled Vertical Model with a ribbed external housing possessing an air input into the internal vented air manifold casted into the housing.

FIG. 6: is a scale drawing showing the exterior side view of a compressed air cooled Vertical Model with a ribbed external housing and air input line.

FIG. 7: is a scale drawing showing a side view cross-section of a basic convection cooled Vertical Model with air filters and outfitted with a custom air brake possessing air filters.

FIG. 8: is a scale drawing showing a side view cross-section of a compressed air cooled Vertical Model with ribbed external housing and outfitted with a custom air brake possessing the compressed air cooling input line.

FIG. 9: is a scale drawing showing a side view cross-section of a compressed air cooled Vertical Model with ribbed external housing possessing an air input into the internal vented air manifold and outfitted with a custom air brake.

FIG. 10: is a scale drawing showing the exterior side view of a basic convection cooled Vertical Model with air filters and outfitted with a custom air brake possessing air filters.

FIG. 11: is a scale drawing showing the exterior rear view without the drive-plate and brake of a basic convection cooled Vertical Model set-up for a custom air brake to show mounting locations.

FIG. 12: is a scale drawing showing the exterior rear view of a basic convection cooled Vertical Model outfitted with a custom air brake with filters.

FIG. 13: is a scale drawing showing a rear view plus side view of a 8″ OD Brake-pad metal mounting back with its accommodations' for air flow through the unit.

FIG. 14: is a scale drawing showing a Steer-by-wire front suspension with a 62.5″ wide wheel track equipped with 240/45 22 tires mounted on 22″ OD×8″ wide rims and outfitted with Convection Cooled Vertical Models with Air Filters and a Custom Air Brake.

### DETAILED DESCRIPTION OF THE INVENTION

MAW-DirectDrives were created to improve the efficiency of transportation utilizing the wheel as their means of motion.

My thoughts centered on the wheel and how to take advantage of their rotation to generate electricity in a manner similar to wind generators.

I tried to incorporate this ability around the brakes and utilize this area to fabricate a means to reduce the burden imposed upon the vehicle to produce motion and research brought about an awareness of various technologies along with their goods marketed today which facilitated my creation of MAW-DirectDrives.

Vertical Models utilize pancake style direct drive motors that eliminate the need for gearing and mechanical braking, due to high constant torque production plus Dynamic and regenerative braking.

The entire conventional process of creating and transmitting torque from a central location by inefficient mechanical means can be eliminated and reduced to one moving part to rotate and stop a wheel regardless of the load it encounters plus by incorporating a second pancake style direct drive motor/alternator the second alternator will assist the vehicle's need for electrical power through self-production generated by the rotation of the wheel itself feeding back into the power supply ultimately increasing the vehicle's efficiency through the incorporation of MAW-DirectDrives design principles which will pave the way to a standard all electric format of propelling all land transportation.

Vertical Models new creative design and configuration position two pancake style direct drive permanent magnets D.C. stators separated from one another and positioned face-to face with matching orientation to one another having between them a two-sided permanent magnets drive-rotor disc possessing on both sides equal numbers of rare earth magnet Arc-Segments located exactly on the same projection lines off center being equal in strength with matching polarities pointing the same direction when mounted onto the drive-rotor creating a tuned and complementary relationship that enables a lower end result in the losses associated with magnetic drag during the production/generation of electrical power by single units, therefore making their association in this format more efficient.

MAW-DirectDrives benefit by gaining redundancy thru incorporating the second stator giving peace of mind knowing if one stator fails a backup is always available for each wheel.

MAW-DirectDrives achieve their higher torque production by increasing the surface area of permanent magnets engaged in the operation of the unit(s) than motors with small internal rotors operating at high rotational speed with less torque and geared down to produce the required amount.

When the height of the rotor (permanent magnets) is kept within the optimum torque production range increasing the surface area of the magnets will increase torque production in proportion to the increase in surface area.

A monumental advantage yielded by the design is their ability to continually transform the kinetic energy the vehicle possesses in proportion to the vehicle's linear momentum, and input back into the supply electricity generated by each wheels second stator, until now this has been an untapped reservoir of energy just being wasted.

An improvement with regenerative braking involves the difficulty at present to fully store/garner the high amount of Back-EMF produced by one large central motor operating at higher RPMs and by distributing evenly the work load to the weight bearing locations (wheels) the increased surface area of permanent magnets coupled with lower operating speeds reduce the Back-electromotive force produced in proportion to the increase in surface area of permanent magnets engaged in operation times the amount of reduction in operating speed making it possible to fully utilize the technology to its ultimate limits.

The design also benefits Dynamic braking and eliminates the need for traditional friction based mechanical formats during motion relegating that format for implementation as emergency/parking applications; by dispersing the electronic braking action/force over a larger surface area of magnets this eliminates losses associated with dynamic breaking's heat buildup which is due to requiring a high ratio of power to surface area of permanent magnets engaged in operation because of so little area to work on, the reduced ratio of power associated with the action will be proportional to the ratio of increase in surface area associated with the action which will decrease the heat buildup accordingly and increase the efficiency and effectiveness of the action proportionately.

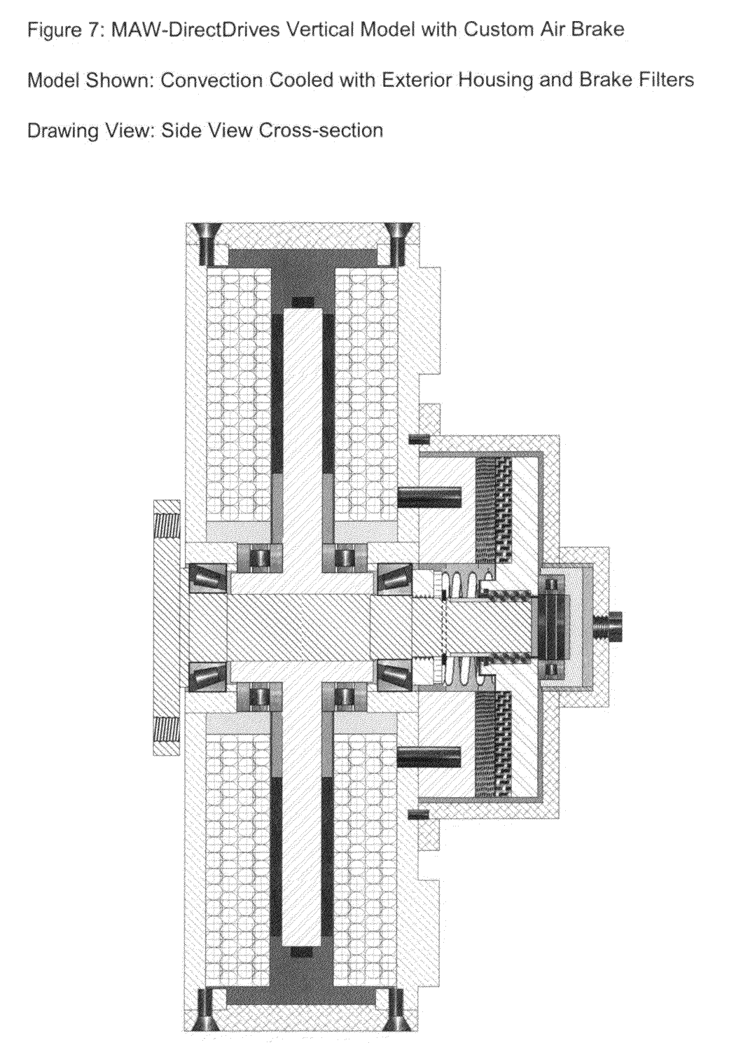

Although the design will allow incorporating various braking technologies and their manufactured goods on the market today a custom air brake design capable of utilizing any pressurized medium is shown in FIGS. 7, 8, 9, 10 and 12. The brake's design incorporates state of the art components and materials for reducing friction with moving parts and reducing heat associated with the braking process plus it incorporates a larger surface area associated with the braking action while maintaining smaller overall dimensional characteristics allowing the unit's miniaturization.

To control the variation in side-to-side rotational speed for steering/navigating vehicles configured with conventional mechanical formats a Rotary Variable Differential Transformer (RVDT) can be incorporated which imparts perfect all-wheel differential steering independently by each DirectDrive unit.

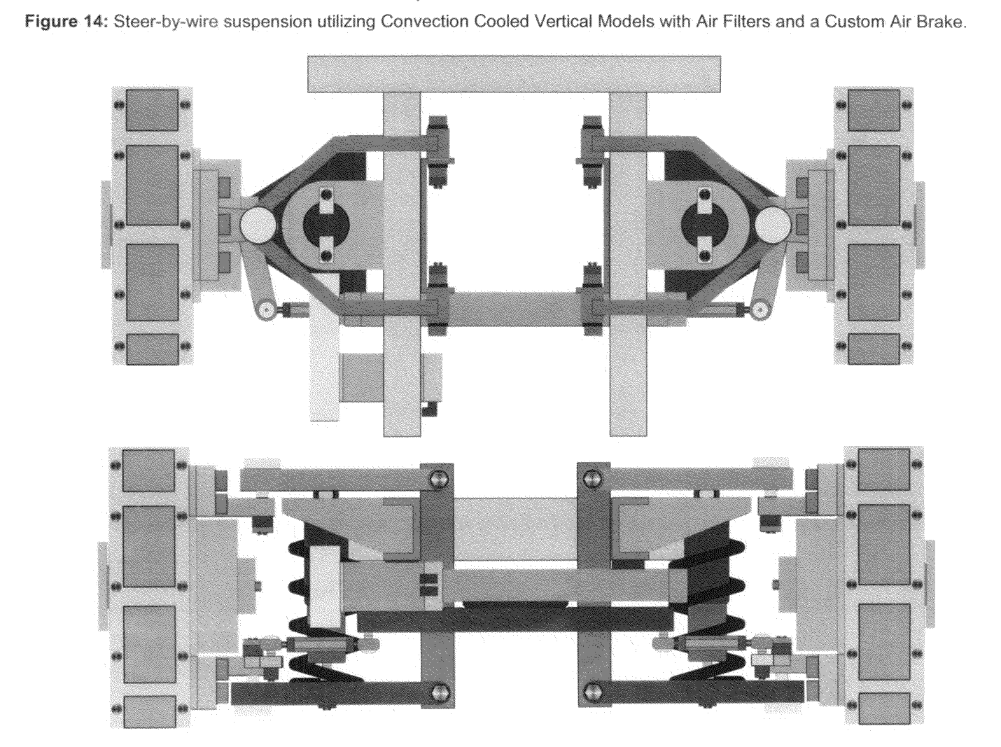

For a steer-by-wire format (ref. FIG. 14) enabling computer (CPU) regulated collision avoidance, speed control via radar and GPS guidance; secure inside the dash and to the end of the steering wheel shaft coming in an Absolute Rotary Encoder which sends the operators commands to the CPU to control the linear motion slide mounted in line with the tie-rod ends to the track rod connected to those tie-rods.

Speed control and braking utilize two identical pressure sensors reacting proportionately to the amount and speed of the applied pressure.

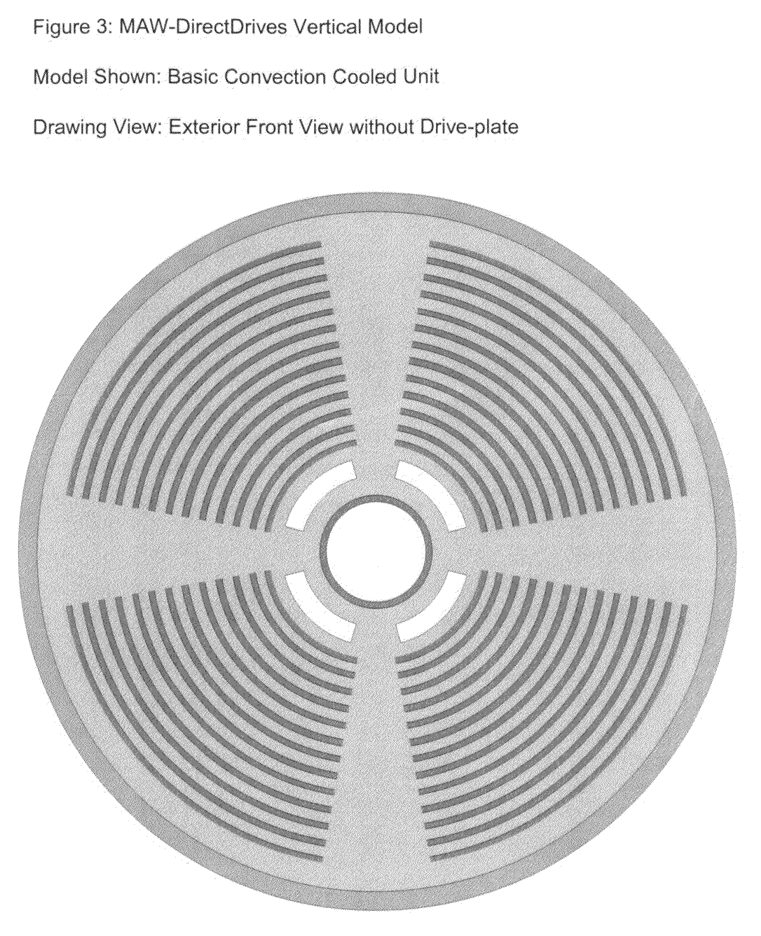

Vertical Models are two stationary pancake style direct drive stators that are separated facing one another with a two-sided permanent magnets drive-rotor disc connected to a machined drive-plate and spindle casting positioned between them to interact and produce rotation, the stators' reinforced externally ribbed (ref. FIG. 3) circular mounting backs serve as the front and rear housing enclosures and have incorporated into their center a wheel bearing housing forming the wheel hub's outside boundaries with the rear mounting back possessing two bosses located at the connection points to the vehicle's suspension machined to facilitate the unit's connection to the vehicle; the only moving part called the Integrated Drive-plate Assembly joins and locks the unit together by its machined and threaded spindle traversing through the wheel hubs' sealed tapered roller bearings and securing them together utilizing a nut, thick washer and external retaining ring with any needed shim washers filling the gap between, the external housing is recessed on both inside faces for the stator mounting backs and adds rigidity and stiffness to the unit plus maintains the parallel relationship of the stators and is secured to the stator mounting backs utilizing flat-head socket cap machine screws whose holes are countersunk for a flush finish.

The Integrated drive-plate assembly casting is a Permanent Mold Casting made with 4340 Alloy Steel conforming to ASTM A320 standards and is a strong sturdy casted metal disk (drive-plate) with a solid stiff well-built shaft projecting back on center, rough casting dimensions are set to require at least 0.125″ of material to be machined off on all surfaces, for casting ease the shaft dimension should be a single dimension set to the largest diameter and all the surfaces are machined true to maintain concentricity and perpendicularity to the stators and two-sided permanent magnets drive-rotor, the spindle portion is responsible for locating and securing both stators and the rigid thickset dual bossed metal disc comprising the two-sided permanent magnets drive-rotor via a press fit for the stators and a keyed press fit for the drive-rotor which possesses on both sides matching rare earth permanent magnet arc-segments that co-act in unison with the stators to produce torque/rotation and generate electricity for reducing the electrical demand the vehicle requires; centered and bonded on the outer edge of the drive-rotor disc are numerous rare earth permanent magnet arc-segments evenly spaced to interact with a digital hall effects sensor positioned above on the inside of the housing for speed and direction information to be input into the computer, the finished integrated drive-plate's spindle portion traverses through the wheel hub to secure and lock the unit together, the spindle behind the drive-plate has a boss to apply pressure to the inner sealed taper roller bearing and properly position the drive-plate plus three different OD lands projecting back the first land accommodates the sealed inner tapered roller bearing following with one slightly reduced in diameter keyed to accept the two-sided drive-rotor then stepping down to the land accommodating the sealed outer tapered roller bearing which is threaded at a point prior to exiting the bearing the width of the lock nut and then steps down to the ending dimension an amount slightly smaller than the bottom of the threads to preserve and maintain structural stability and soundness by retaining as much bulk as possible, farther down the shaft behind the threaded section on the final ending dimension resides the groove that accommodates the external retaining ring working in conjunction with one thick spacing washer plus the necessary and appropriate amount of shim washers to completely fill the gap between the external retaining ring and the tightened and torqued lock nut that locks and joins the two assemblies together.

The Integrated drive-plate assembly on units without supplemental/parking brakes are dimensioned for the spindle to die/terminate just outside the unit's rear face and the wheel hub opening is covered with a metal dust cap secured to the mounting back to keep the unit clean inside, the dimensional specifications for the patent application's reference model are the following for the casting: 6.125″OD±0.032″×0.750″W±0.032″ drive-plate stepping down to 3.000″OD±0.032″×0.219″W±0.032″ boss with the spindle 1.750″OD±0.032″×6.281″W±0.032″ overall length is 7.250″, the following finish dimensions unless noted are machined to a 64 μin finish: 6.000″OD±0.002″×0.625″W±0.002″ drive-plate with 6 holes tapped for ⅝-18unf threads on a 4.750″BC spaced 60° apart on center and stepping down behind the drive-plate a boss 2.750″OD±0.002″×0.219″W±0.002″ stepping down for inner bearing land 1.625″OD±0.000″ with a 32 μinfinish terminating 1.109″±0.002″ from the drive-plate then stepping down for the drive-rotor land having a 0.375″W−0.000″+0.002″×3.250″L±0.005×0.190″D±0.010″ keyway that is 1.5625″OD±0.000″ with a 32 μinfinish terminating 4.594″±0.002 from the drive-plate which steps down to the outer bearing land with a 32 μin finish 1.500″OD±0.000″ terminating 5.469″±0.002″ from the drive-plate that is threaded starting 4.969″ from the drive-plate with 1½-12unf threads then stepping down to the end dimension 1.375″OD±0.002 terminating 6.469″±0.002″ from the drive-plate grooved 0.093″W−0.000″+0.002″×0.053″D±0.002″ starting 6.172″±0.002 from the drive-plate for the external retaining ring.

The Integrated drive-plate assembly's spindle on units utilizing the Custom Air Brake requires extending the length of the spindle enough to facilitate the travel of the brake rotor and the outer diameter surface of the spindle's end requires milling six longitudinal concave grooves starting from the spindle's end and going forward the [width of the brake rotor plus the length of the brake rotor's travel] making sure to have clearance/spacing to external retaining ring, the depth and the radius of the longitudinal concave grooves coordinate and correlate with the diameter and positioning of the incorporated tungsten carbide metal balls used within the rotor's incorporated ball spline which is the format used for its travel.

The Integrated drive-plate assembly's spindle on units incorporating supplemental braking formats like fail-safe or power-off technologies can be adapted to accept any of a large variety on the market today by simple splining, milling in keyways or slots, etc . . . .

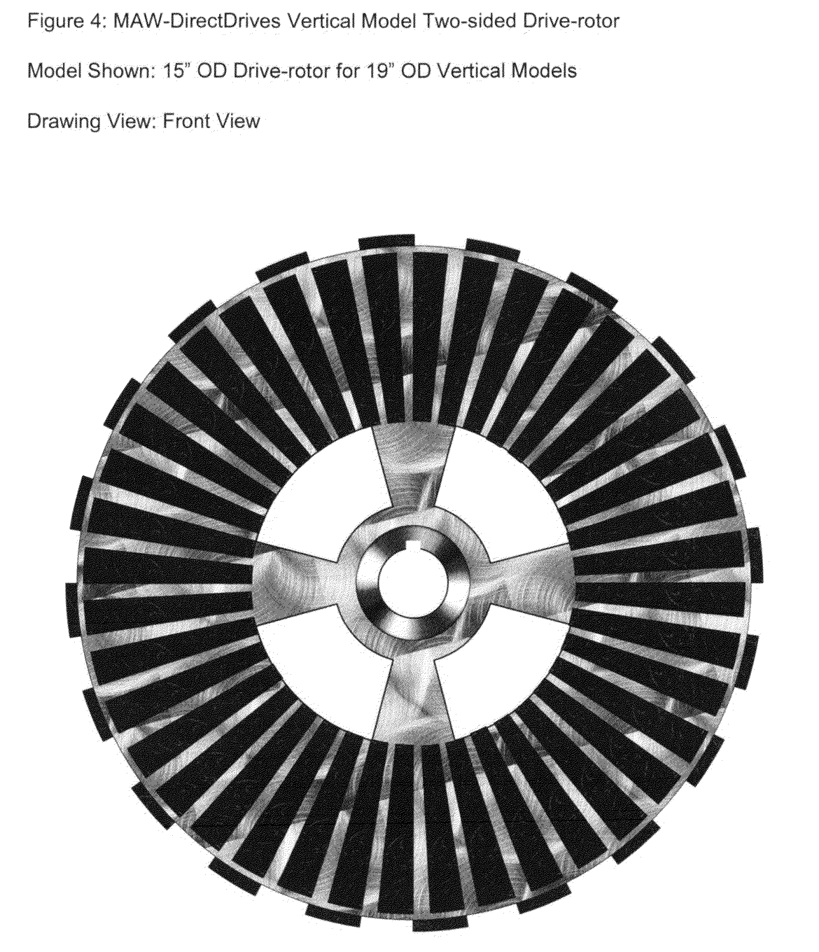

The two-sided permanent magnets drive-rotor disc casting is a Precision Investment Casting made with 17-4PH Stainless Steel conforming to ASTM A747/A747M standards the material is solid, hard and rigid with very little expansion and dimensional deviation due to heat and stress plus its physical properties create resistance to abrasion, corrosion and oxidation for maintaining a long lifespan and is ferromagnetic which lets the rare earth magnets be expeditiously mounted to speed-up assembly and reduce costs, the casting starts out 0.125″ oversize for the thickness and OD of the disc in addition to the OD and each bosses width coming off each side of the disc plus the disc has four vacant annular sectors with an outside radius equaling the inside radius of the rare earth magnet arc-segments and an inside radius set to the cylindrical roller thrust bearings outer diameter and the degree of occupation set to four equal amounts of the remaining area after subtracting the occupation of four structurally needed solid annular sectors and is machined to the finish dimensions plus bored, reamed and keyed at the center (ref. FIG. 4); on the outer surface of the disc between the drive-rotor's magnets are neodymium magnet arc-segments that are evenly and equally spaced using a size that will have an episode of contact frequency with the digital Hall-Effects sensor positioned and secured above to the inside of the housing not exceeding the desired operating frequency range of the sensor when operating at the highest R.P.M. [Example: operating frequency range of sensor is 1 Hz to 20 kHz and the unit's maximum operating speed is 1,000 R.P.M. divide 20,000 by 1,000 and the answer is 20 so 20 magnets are positioned 18 degrees apart on center and sized to create a 50% duty cycle].

The dimensional specifications for the patent application's reference two-sided drive-rotor casting are: 15.125″OD±0.032″×1.063″W±0.032″ disc with 4 finished size vacant annular sectors 7.250″OD±0.005″×3.543″ID±0.005″×60° W positioned 90° apart on center and 2 identical bosses 1 on each side coming out from center 2.685″OD±0.032″×1.437″ID±0.032×1.313″W±0.032 the following finish dimensions unless noted are finished to a 64 μin finish 15.000″OD±0.002″×0.938″W±0.002″ disc with both bosses 2.558″OD−0.002″+0.000″×1.219″W±0.005″ having at center a 1.5625″ID±0.000″ with a 32 μinfinish that is keyed 0.375″W−0.000″+0.002″×0.200″D±0.005″ all the way through, the sealed cylindrical roller thrust bearings utilized within the reference model are 3.937″OD±0.000″×2.5591″D±0.000″×1.063″T±0.000 which creates 0.030″ clearance between the stators and the drive-rotor with its attached 0.250″T±0.000″ magnets and their 0.0005″ nickel coating.

The drive-rotor's rare earth magnet arc-segments have identical magnetization plus polarization and are bonded to the drive-rotor with high temperature two-part epoxies utilizing a jig on each side to maintain their proper alignment having the primary magnetic north edge with the secondary magnetic north face always pointing in the same direction attracting one another during assembly.

Rare earth magnet compositions vary and offer distinct characteristics such as Neodymium magnets produce the highest amounts of gauss which is the density of magnetic flux expressed by the number of MGOe (megagauss-oersteds); Neodymium magnets range from 22 MGOe to 55 MGOe today but the most powerful versions can only operate up to 176° F., high temperature grades produce proportionately less gauss as operating temperatures rise thus compositions operating up to 446° F. produce just barely more than Samarium Cobalt magnets whose operating range is 482° F. to 572° F. and produce 20 MGOe to 32 MGOe.

When the rare earth magnet composition and the magnetic properties have been determined the individual magnet arc-segments are ordered by their inside and outside radiuses equating to their length and the number of arc degrees it occupies within the circle equating to their width, when the mounting of the magnets have cured the drive-rotor sub-assembly is brought to finish dimensions on both sides of the disc bearing the magnets by the process of wet grinding to tolerances of ±0.002″ then a 0.0005″ Ni (nickel) protective coating is applied by electroless plating.

Vertical Models can utilize all the various winds for pancake style stators marketed today which are bonded to their mounting backs and encapsulated in resin then the face is machined and ground to the finished dimension, this patent application's stator dimensions equal larger more powerful sizes marketed today and when requirements demand smaller less powerful stators the unit's size will reflect the decrease in size accordingly.

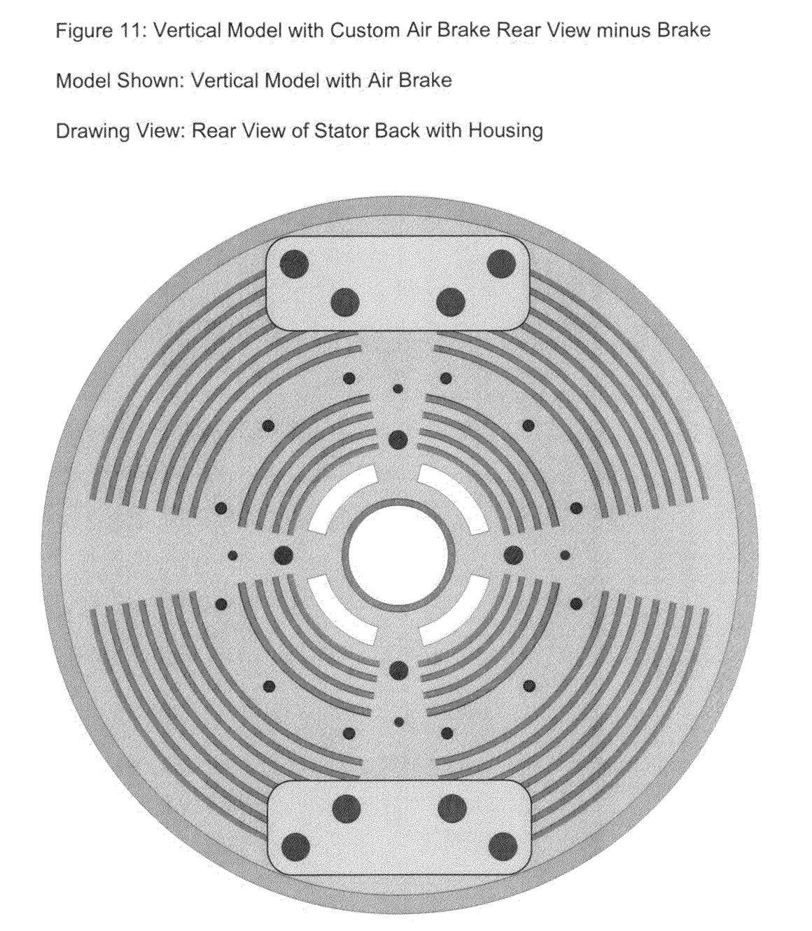

The following stator mounting back being detailed is the front stator (ref. FIG. 3) and the corresponding rear stator mounting back with its stator includes provisions for securing the unit to the vehicle's suspension and any needed accommodations for optional air brakes when employed (ref. FIG. 11), said stator mounting backs casting is 18.100″OD±0.010″×2.500″ID±0.005″ with a wall thickness of 0.500″T±0.005″ including an outer inside ridge 18.100″OD±0.010″×16.750″ID±0.005″×0.625″T±0.005 and an inner inside ridge 4.000″OD±0.005×2.500″ID±0.005″×1.344″T±0.005″ and incorporates a stator 16.900″OD±0.005″×5.000″ID±0.005″×1.500″T±0.001 after grinding; the casting is a Precision Investment Casting made of Cast Aluminum Silicon Bronze Standard composition CuAl5SiFe conforming to ASTM B283 REV A standards, requiring after machining and grinding the inside face subsequent to the stator's mounting, machining the OD to the finished dimension 18.000″OD−0.002″+0.000″×1.000″W±0.001″ and machine the inside wheel hub face to a depth of 0.781″±0.001″ from the stator's face, plus finish machine the wheel hub from the outside face by boring a 2.625″OD±0.002″ hole and counter-boring to 3.000″OD±0.000″×0.969″D±0.002″ to accept a 3.000″OD×1.625″ID×0.875″T inner or 3.000″OD×1.500″ID×0.8125″T outer sealed taper roller bearing whichever applies plus drilling and tapping 12 locations 30° on center 0.500″±0.002″ in from face to a depth of 0.600″±0.010″ for ⅜-24unf threads, the casting's face has concentric annular cooling ribs that are 0.225″T±0.005″×0.350″D±0.005″ spaced 0.450″ apart on center equating to 0.225″W±0.005″ spacing between with the outermost rib positioned on center at a diameter of 15.950″±0.005″ and ending with the innermost rib centered at 6.050″Dia.±0.005″ with all exposed edges having a radius of 0.100″ the annular area influenced by the cooling ribs are interrupted with four identical solid annular sectors occupying 20° apiece positioned 90° apart on center and located centrally are four identical vacant annular sectors for air flow having a 5.000″OD±0.005″×4.000″ID±0.005 occupying 60° apiece positioned 90° apart on center and centered 45° off the centerline of the solid annular sectors previously mentioned.

The rear stator mounting back on models not incorporating the optional custom air brake needs only to add two bosses to facilitate the unit's mounting to the vehicle's suspension for reference purposes the patent application's model (ref. FIG. 11) incorporates into the casting two rectangular bosses 2.500″H±0.010″×7.000″W±0.010″×0.500″T±0.010″ with the corners having a 0.750″R positioned centered on the vertical axis and 7.700″ from center-point to center on the horizontal axis creating 12.900″ space between the bosses which each have four holes drilled and tapped 1.000″D±0.005″ for ¾-16unf threads, two positioned 0.750″ in from outer edges to the center-point and two positioned 1.750″ in from outer horizontal edge and 1.375″ in from vertical edges.

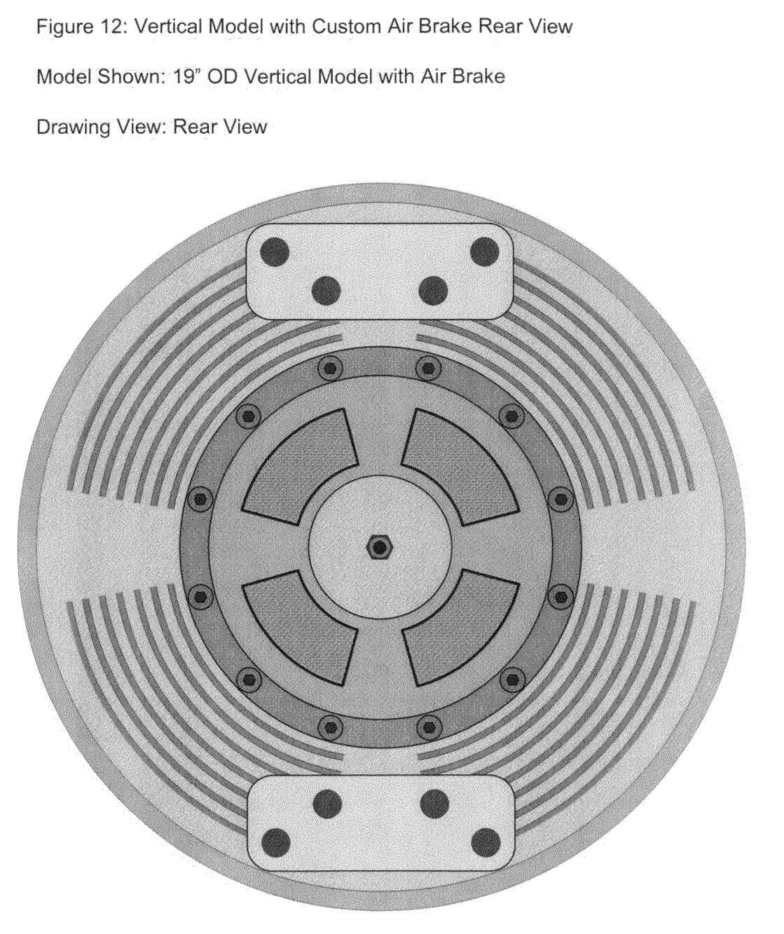

The rear stator mounting back on models incorporating the optional custom air brake merge the area of three cooling ribs together to form an annular land serving as the mounting surface for the brake housing (ref. FIG. 11), said mounting surface starts at the rib centered on 10.550″Dia.±0.005″ and terminates at the rib centered on 7.850″Dia.±0.005″ in addition located on a 9.750″BC (bolt circle) are 12 holes drilled and tapped 0.500″D±0.005″ for 5/16-24unf threads spaced 30° apart positioned 15° off the vertical axis for securing the brake housing (ref. FIG. 12) plus located on a 8.813″BC are 4 housing location holes 0.250″Dia.±0.000″×0.500″D±0.005″ spaced 90° apart positioned on the vertical axis and for holding the brake-pad located on a 6.100″BC are 4 location holes 0.500″Dia.±0.000″×0.500″D±0.005″ spaced 90° apart positioned on the vertical axis.

An easy method for connecting MAW-DirectDrives to a vehicle's front suspension is taking the steering knuckle and dividing it in two and position vertically at the top and bottom outside the confines of any supplemental braking format when incorporated as previously explained and shown in FIG. 14 which illustrates the front suspension of a vehicle with a 62.5″ wheel track riding on 240/45 22 tires mounted on 22″OD×8″ wide rims requiring heightened ground clearance which can be inverted to lower the center of gravity plus create greater protection and shelter for the components from the elements.

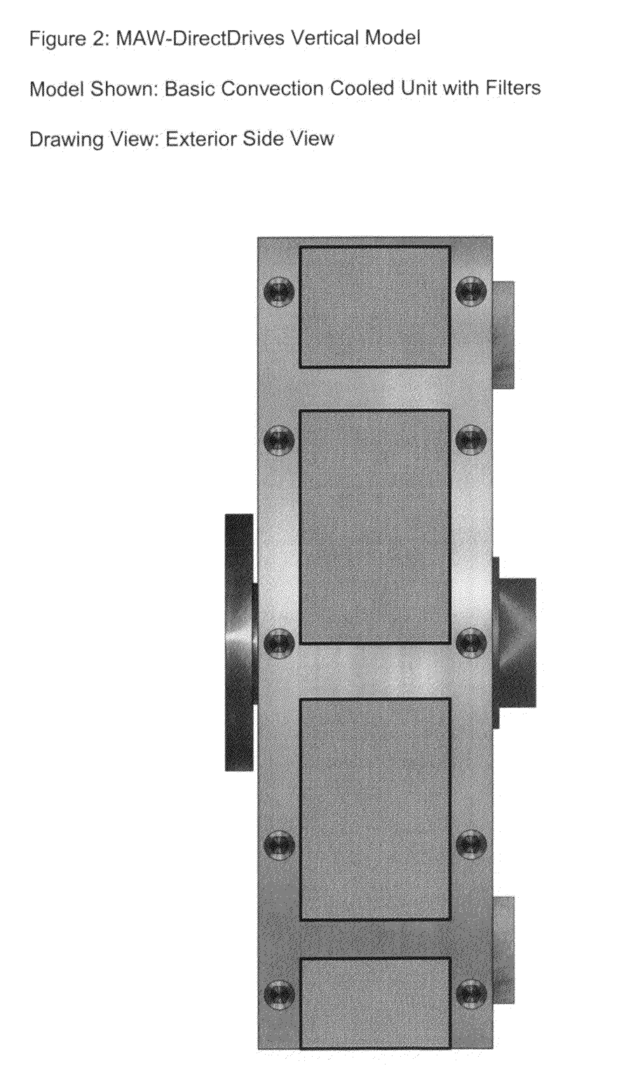

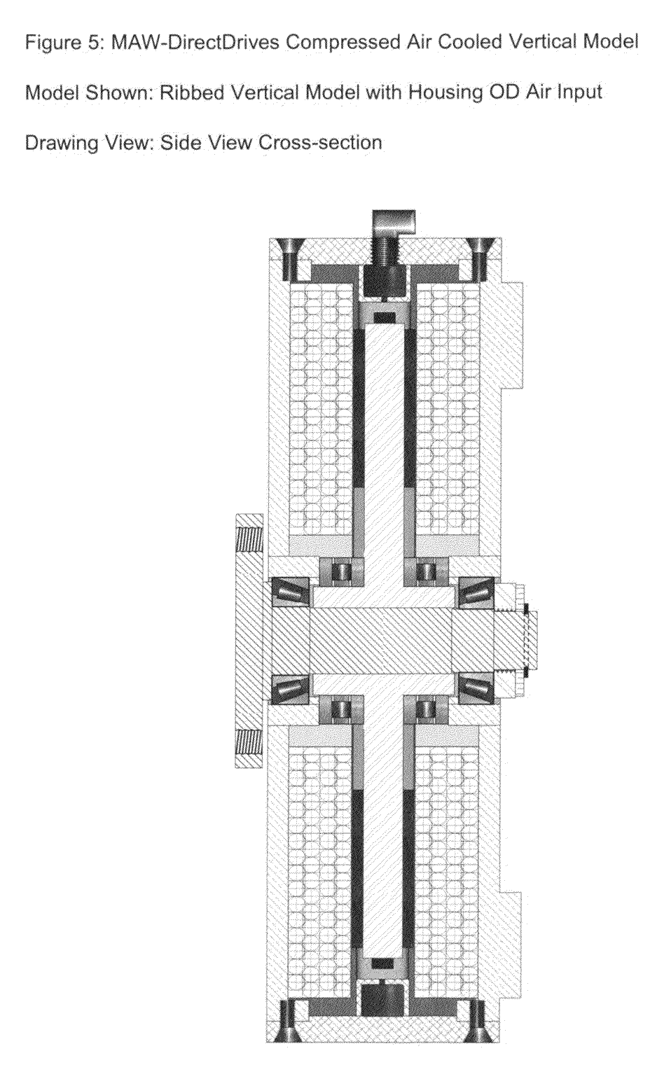

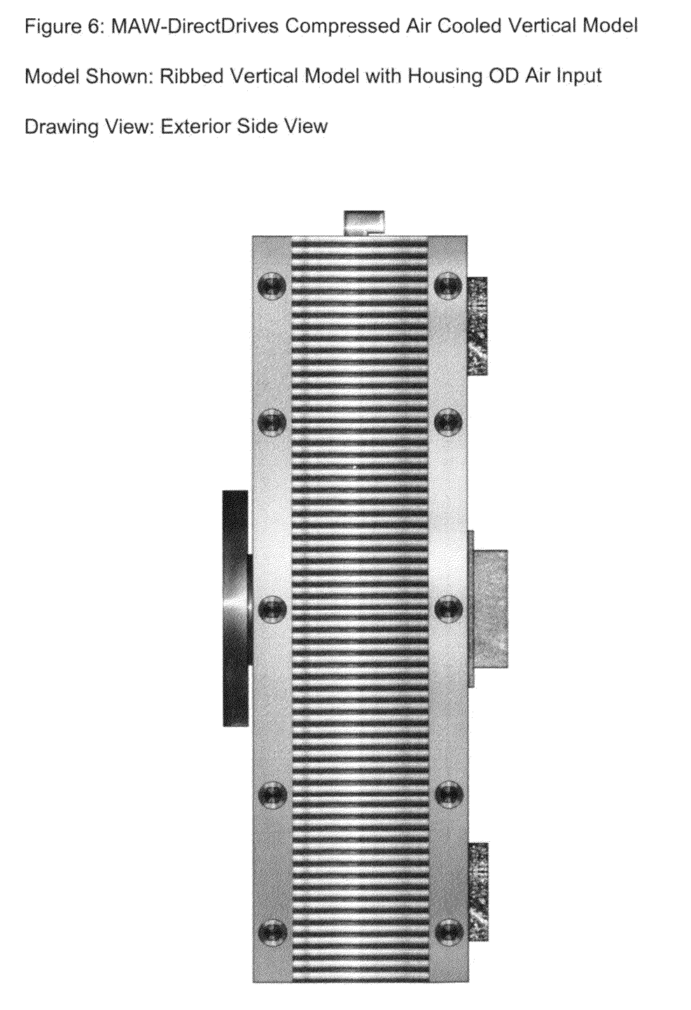

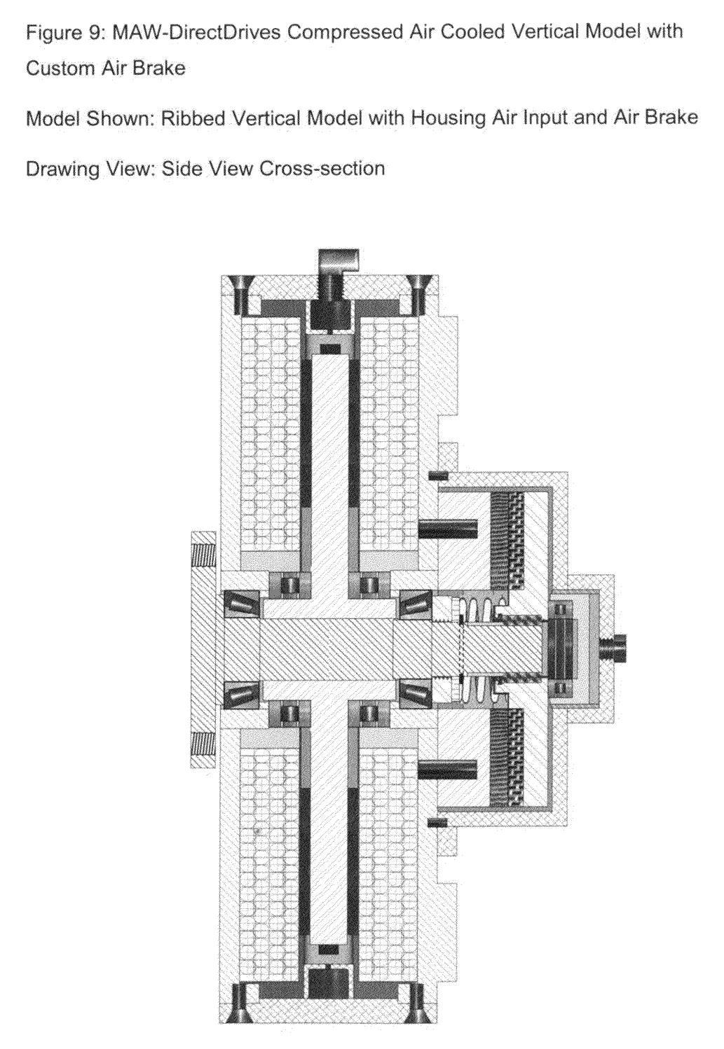

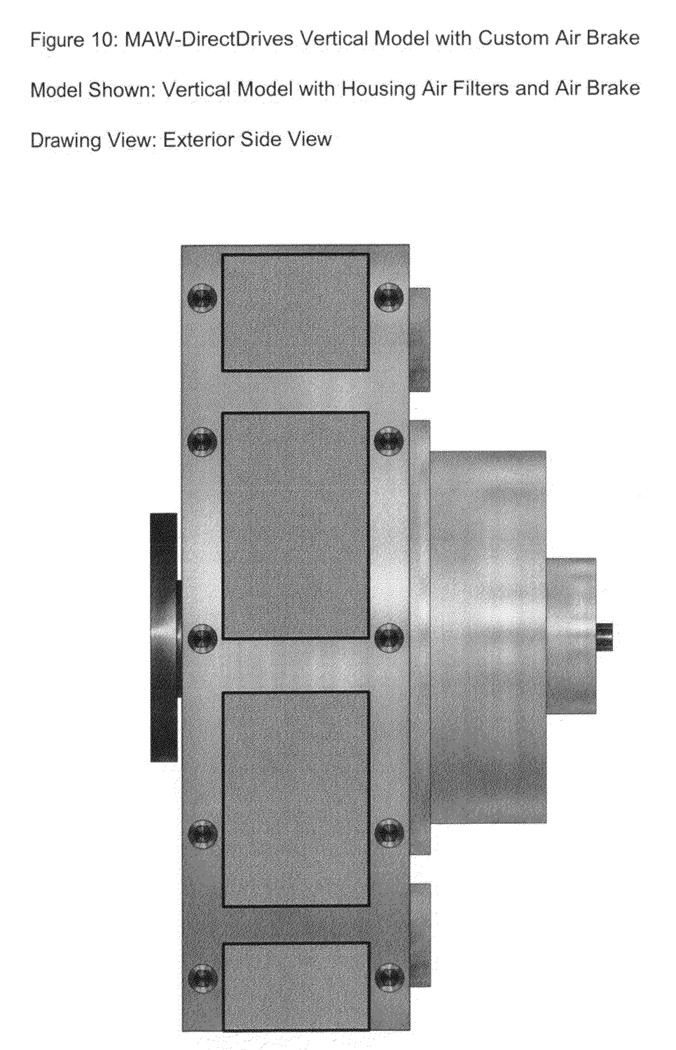

There is three configurations of the outer housing for Vertical Models to employ depending on your cooling preference, one incorporates curved rectangular openings possessing air filters to enable easy air-flow (ref. FIGS. 2 and 10), the other two have centered into the outer diameter surface short horizontal cooling ribs circumnavigating the housing encompassing the same area as the air filters to aid cooling (ref. FIG. 6) with one version incorporating into the casting on the inside a round rectangular shaped air manifold protruding down from the center with numerous small venting holes evenly placed and centered around the manifold's ID to allow the escape of compressed air entering via a fitting on the outside positioned on the top centered on the vertical axis (ref FIGS. 5 and 9); for producing economical high quality housings capable of sufficient stiffness and rigidity plus be noncorrosive, nonoxidating, hard and tough and be casted to the finished dimensions on the ID and OD including all counter-sunk mounting holes and cooling formats requiring only machining inside recesses to finish dimensions the casting is a Precision Investment Casting made with Zinc-Aluminum alloy ZA-27 conforming to ASTM B240 standards.

All three outer housing versions used on the patent application's reference Vertical Models are casted to: 19.000″OD±0.005″×17.750″ID±0.005″×5.500″W±0.005″ with a machined recess on each outer inside edge finished to 18.000″ID−0.000″+0.002″ terminating inward 1.750″±0.001″ from the center-point and each side has 12 countersunk holes spaced 30° apart on center and centered 2.250″±0.001″ from the center-point sized for a ⅜-24unf flathead socket cap machine screw to be flush with the surface in addition the top 24° of space centered on the vertical axis is allocated as the area for input-output connections.

The outer housing incorporating curved rectangular air-filter openings have eight identical openings centered into the housing OD and are 3.400″W−0.000″+0.005″×35° L−0.000″+0.005″ which equals on a 19.000″OD a length 5.806″ positioned 24° apart 12° off the vertical axis for the top two openings and having 8° spacing between the remaining openings, each opening has a solid 0.125″Dia. bead projecting 0.0625″ out from the inside edges positioned centered 0.3125″ in from the outside surface around the entire opening to secure the curved air filters configured with an opposing profiled 0.625″H±0.002″×0.200″W±0.010″ frame made by injection molding with injection molding grade Acrylonitrile-Butadiene-Styrene (ABS).

The outer housing incorporating only horizontal cooling ribs are utilized when incorporating compressed air cooling being input through the brake housing or when requiring greater sealing properties for the unit; the ribs are centered into the housing OD and are 3.500″L±0.005″×0.203″W±0.005×0.425″H±0.005″ with 0.172″±0.005″ spacing between ribs with all exposed edges having a radius of 0.062″ the ribbing circumnavigates the housing except for the top 24° of space centered on the vertical axis allocated for the input-output connectors.

The ribbed outer housing incorporating an internal annular shaped compressed air manifold for cooling the unit's interior with compressed air incorporates centered on the inside surface a manifold 1.000″H±0.005″×1.250″W±0.005″ with an interior opening 0.850″H±0.005″×0.950″W±0.005″ with 0.0625″ radiuses on all inside and outside corners and edges in addition to having twelve 2.75 mm vent holes spaced 30° apart on center centered on the inside surface; the manifold is fed by a ⅜″MNPT 90° street elbow connector secured into the housing's corresponding threaded hole located centered on the vertical axis of the housing's upper exterior.

At this stage of MAW-DirectDrives Vertical Models description that being without mechanical brakes some of their many applications are powering large centrifugal pumps, heavy machinery that presently use frameless direct drive motors, elevators and cranes, any situation needing efficient high torque production especially where space is limited, subways or anything using a large motor to maintain rotation of a flywheel in conjunction with a clutch, present wind turbine generators gain with dual stators able to produce more in practically the same space and etc.

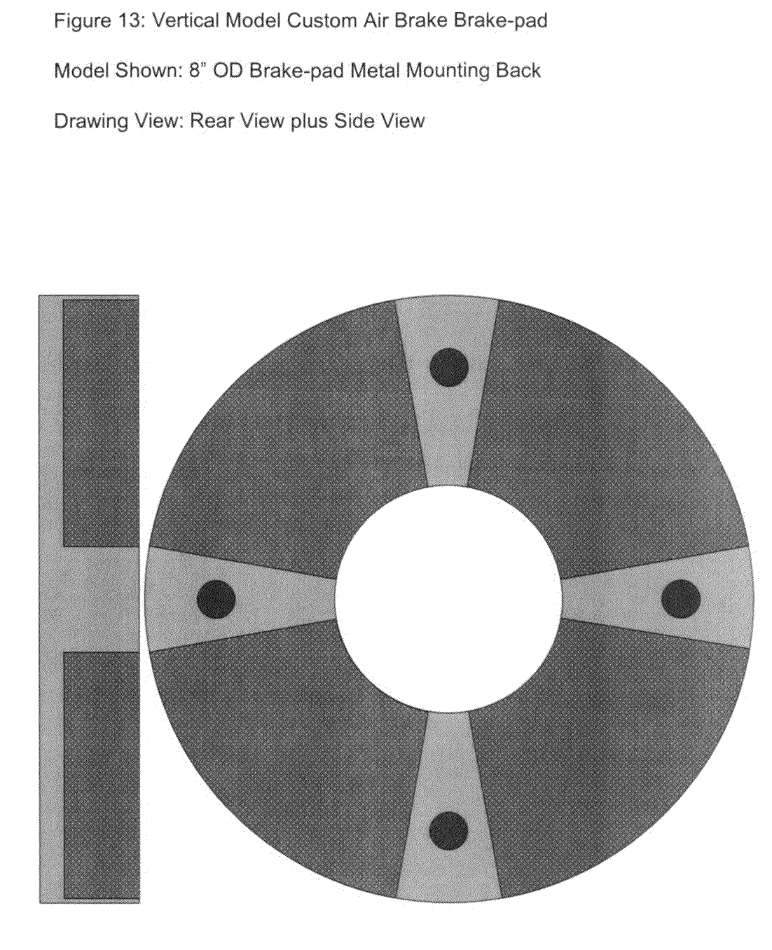

Vertical Models can incorporate an array of brake technologies on the market today and the following custom air brake (ref. FIGS. 7, 8 and 9) is able to utilize any pressurized liquid or gas medium capable of safely actuating movement of a piston within a cylinder it utilizes state of the art braking materials that are more efficient at stopping and reducing heat during the braking action that are found on formula race cars but considered too expensive for use on passenger vehicles and allows these materials to be reduced dramatically in volume by miniaturizing the brake unit so the material is economically feasible while at the same time have more surface area engaged during the breaking action making them more effective in a smaller area, all this while incorporating the best friction reducing formats of operation like the brake rotor's ball spline format of travel across the spindle to extend its life expectancy the custom air brake's brake rotor takes the form of a heavy disk and circular boss projecting inward that houses the ball spline, to prepare the ball spline the boss's face is drilled with six small holes on a bolt circle which allows the incorporated metal balls to pierce the area of the spindle with its mating configuration of longitudinal concave grooves to the specified depth and be spaced 60° apart on center plus reamed 0.002″ larger than the incorporated Tungsten Balls to a depth 0.150″ less than the brake rotor's width then the ID is bored through to 0.020″ larger than the spindle's OD and counter-bored to a depth and diameter that permits an internal retaining ring to be incorporated unobstructed and its grooved for holding in the metal balls, the outside diameter of the boss is dimensioned slightly smaller than the ID of the Die Spring used to disengage the brake rotor which rests around the boss applying pressure to the brake rotor and the unit's locknut spacing washer and the Die Spring OD is slightly smaller than the stator mounting back wheel hub ID which coincides with the ID of the brake-pad and its metal mounting back that is held in place on four stout location pins pressed into the stator mounting back, the brake-pad's metal mounting back has four indented areas designed into them for cooling and permitting air flow behind and through the unit (ref. FIG. 13) via the stator mounting back's air circulation openings (ref. FIG. 11) the brake-pad material is Carbon Kevlar which interacts with the carbon fiber reinforced ceramic inserts recessed into the brake rotor that is encased within a housing secured to the rear stator mounting back and incorporating an air cylinder to apply pressure to the brake rotor in proportion to the input pressure, the brake rotor when engaging traverses inward on the spindle with the aid of a sealed tapered roller thrust bearing set into the piston allowing the spindle's travel through its center and the piston travels within a bushing pressed into the air-cylinder portion of the brake housing that is customizable and able to incorporate air filters for efficient air flow or solid and have a compressed air input line to direct air flow through and out the unit for cooling or just solid to restrict environmental contaminants.

The brake housing's three reference versions are all dimensioned exactly the same and the casting is a Precision Investment Casting made with Aluminum Alloy A390.0-T6 conforming to ASTM B618 standards, all interior and exterior dimensions are cast to the finished specifications with a 64 μinfinish and require all exposed corners and edges inside and outside to have a 0.050″R (radius), the housing is also cast with twelve finished countersunk mounting holes on a 9.750″BC spaced 30° apart on center sized for 5/16-24 flathead socket cap machine screws to be flush with the top face of the mounting ring located at the bottom of the brake housing, the brake housing mounting ring is 10.500″OD±0.005″×0.500″H±0.005″ on a 9.000″OD±0.005″×8.250″ID±0.005″×3.313″H±0.005″ exterior×2.938″H±0.005″ interior brake housing incorporating an air-cylinder housing centered on top 3.750″OD±0.005″×2.950″ID±0.005″×1.250″H±0.005″ that is bottom reamed to a 3.0625″ID±0.000″ and sleeved with a 3.0625″OD±0.000″×2.8755″ID±0.000″×1.250″W±0.005 Silicon Nitride liner with a 2.875″OD±0.000″×1.125″W±0.002″ piston/rod made of Air Hardening Drill Rod bored 1.385″OD±0.002″×0.750″D±0.002″ and counterbored 2.3125″OD±0.000″×0.563″D±0.002″ to insert a sealed tapered roller thrust bearing 0.3125″OD×1.385″ID×0.625″W, then ending with drilling four location holes 0.250″OD±0.000″×0.281″D±0.002″ on a 8.813″BC spaced 90° apart centered on the vertical axis.

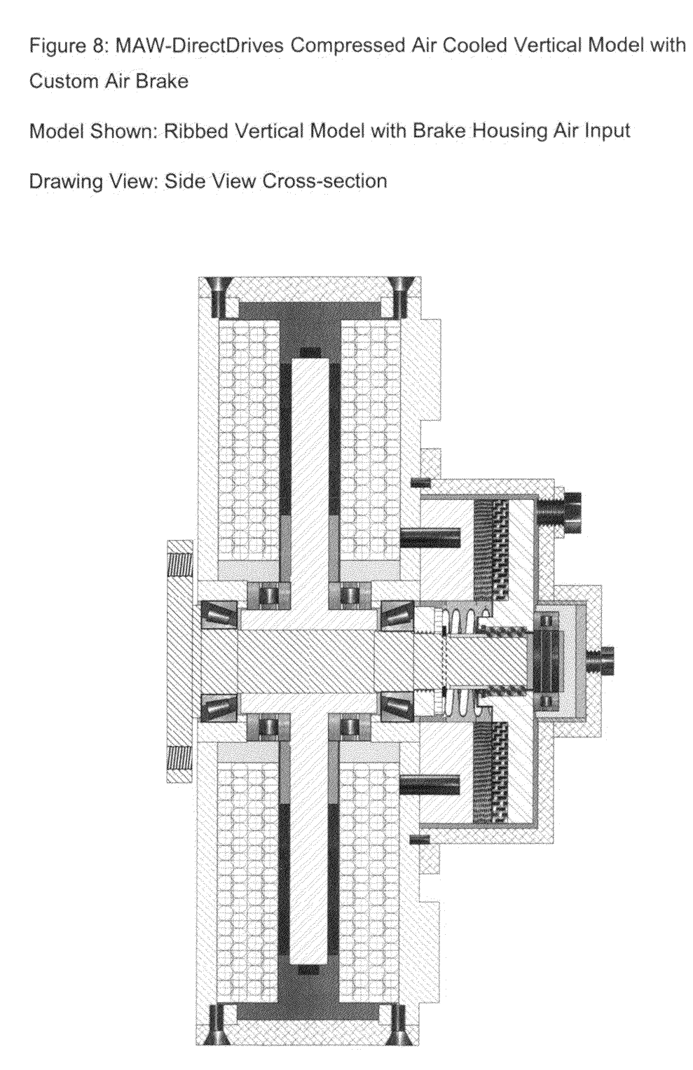

The brake housing detailed above [0079] represents the model having a solid rear face (ref. FIGS. 9 and 10), for the model incorporating an air input line (ref. FIG. 8) the location designated for the input line requires a boss 1.250″OD×0.250″T incorporated into the casting to facilitate the threaded hole accommodating a ⅜″MNPT−⅜″FNPT Coupling, for the model incorporating air filters (ref. FIGS. 7 and 12) there are four vacant annular sectors 7.500″OD−0.000″+0.002″×4.500″ID−0.002″+0.000″×60° W spaced 90° apart on center and centered 45° off the vertical axis creating four 30° solid sections centered on the vertical and horizontal axis, each opening has a solid 0.125″Dia. bead projecting 0.0625″ out from the inside edges positioned centered 0.1875″ in from the outside surface around the entire opening to secure the identical opening configured air filters designed with opposing profiled outer edges 0.500″H±0.002″ with a 0.125″H×0.125″W×0.125″R top outer lip designed onto the 0.200″W±0.010″ frame made by injection molding with injection molding grade Acrylonitrile-Butadiene-Styrene (ABS).

The brake rotor casting for the reference model is a Plaster Cast made of Phosphor Bronze conforming to ASTM B139/B139M-07 standards, the rough casting requires 0.125″ of material to be machined off to bring to the finished dimensions and has the following specifications: 8.125″OD±0.020″×1.125″ID±0.020″×0.750″W±0.020″ disc with a large boss centered on the rear face 3.125″OD±0.020″×1.125″ID±0.020″×0.375″W±0.020″ and a small boss centered on it 2.328″OD±0.020″×1.125″ID±0.020″×0.406″W±0.020″, the finished specifications for the brake rotor are: 8.000″OD±0.002″×0.625″W±0.002″ disc with the large boss 3.001″OD±0.001″×0.375″W±0.002″ and the small boss 2.203″OD±0.002″×0.406″W±0.002, the rear face of the disc has a 8.000″OD±0.002″×3.000″ID−0.000″+0.002″×0.375″W±0.002″ Carbon Fiber Reinforced Ceramic braking surface insert bonded to it; the ball spline is configured with the following specifications: six 0.250″OD±0.002″×1.172″D±0.005″ holes are bored on a 1.525″BC±0.000″ spaced 60° apart on center and reamed 0.252″OD±0.000″×1.172″D±0.005″ to hold four 0.250″ Dia. Carbide Metal Balls apiece then the ID is through bored 1.393″ID±0.002″ and counterbored 1.625″ID±0.002″×0.188″D±0.005″ then a 0.068″W−0.000+0.002″ groove is machined to a depth of 1.725″OD±0.002″ and positioned 0.168″±0.002″ inward from the rear face to the innermost portion to hold a Spirolox Internal 2-Turn, Heavy Duty Spiral Retaining Ring with the following specifications when sprung: 1.742″OD×1.486″ID×0.062″T, the spindle has six 0.126″R×1.906″L±0.005″ longitudinal concave grooves milled in to a depth of 0.052″−0.000″+0.001″ spaced 60° apart on center matching the brake rotor's ball spline configuration; the incorporated die spring is made of 0.250″H×0.125″T Chromium-Vanadium Alloy Steel Spring Wire conforming to ASTM A231/A231M-10 standards and is: 2.750″OD×2.250″ID×2.125″L free length with five coils and the ends are ground.

The brake-pad mounting back casting is a Plaster Cast made of Ductile Cast Iron that is casted to its finished dimensions: 8.000″OD±0.010″×3.000″ID±0.010″×1.344″T±0.010″ with a Carbon Kevlar braking surface sized 8.000″OD±0.010″×3.000″ID±0.010″×0.438″T±010″ bonded to the mounting back's face (ref. FIG. 13), the rear face has four 0.469″OD±0.002″×1.100″D±0.005 drilled holes on a 6.100″BC spaced 90° apart on center and centered on the vertical axis that are bottom reamed to 0.500″OD±0.000″×1.016″D±0.002″ to hold 0.500″OD±0.000″×1.500″L±0.002″ Carbide Dowel Pins for locating and securing the brake-pad to the stator mounting back, also incorporated into the casting's rear face are four recessed annular sectors for cooling and air circulation through the unit sized: 8.000″OD±0.010″×3.000″ID±0.010″×1.000″D±0.010″×70° W spaced 90° apart on center and centered 45° off the vertical axis creating four 20° W solid sections centered on the vertical and horizontal axis.

What is claimed is:

1. A permanent magnets direct drive propulsion, brake and electrical generation unit for a wheel, said direct drive unit comprising: two pancake style direct drive permanent magnets BLDC stators mounted on strong sturdy casted annular shaped metal discs functioning as the unit's stationary outside faces with an inner ridge of metal coming off the outside diameter for adding stiffness and facilitating the attachment via flat head machine screws of an external housing which keeps the unit rigid and parallel and also having a thicker more pronounced ridge coming off the inside middle forming the outer portion of the unit's inner and outer wheel hub which possess sealed tapered roller bearings in addition the outer faces have circular ribbing on the exterior spanning the area of stator occupation on the inside to enhance cooling plus vacant annular sections between the stator and wheel hub exterior to allow heat evacuation from the unit that is configured with the two stators and their mounting backs facing one another with a solid two-sided permanent magnets drive-rotor disc positioned between them possessing equal amounts of identical flat permanent magnet arc segments bonded to each side with their polarities facing the same direction to enable working with the stators in a complementary relationship accomplishing two functions simultaneously thus increasing the units efficiency and functionality with only one moving part the Integrated Drive-plate Assembly that is a casted and machined strong and sturdy drive-plate for mounting a wheel and tire to with a spindle projecting back on center coming off of a centrally located boss used to position the drive-plate at its specified distance from the front face of the unit and ride against the outer sealed taper roller bearing holding it in place then stepping down to a land that is keyed and machined to a press-fit dimension mirroring the specifications of the two-sided drive-rotor for the mounting and positioning of the two-sided drive-rotor which also incorporates at each side a wide boss coming off center turned to a diameter equaling the inside diameter of sealed cylindrical roller thrust bearing used on each side to ride against the stator mounting back and drive-rotor disc and maintain the specified clearance between the stator's face and face of the permanent magnets bonded to the drive-rotor disc for proper operation and adding stiffness and rigidity to the drive-rotor, after the machined land designated for the drive-rotor is a smaller diameter land dimensioned for accepting the ride of the inner sealed taper roller bearing incorporated into the rear stator mounting back then at a point directly before exiting the bearing the spindle is threaded to a width equaling the width of the lock nut which cinches and secures the unit together then the spindle's diameter is reduced to its ending specification set just below the bottom of the threads that has a groove machined into it a small width behind the lock nut to accept an external retaining ring with a spacing washer and any needed shim washers filling the gap between the lock nut and retaining ring to facilitate maintaining the specified torque on the lock nut for proper operation with a zero gap remaining preventing any loosening.
